(19) United States
(12) Patent Application Publication
(10) Pub. No.: US 2008/0308159 A1
(43) Pub. Date: Dec. 18, 2008

(54) Top entry swing check valve

(76) Inventor: Gerald A. Stunkard, Jenks, OK (US)

Correspondence Address: JAMES L. JACKSON;James L. Jackson, PC, 10723 Sugar Hill Dr., Houston, TX, 77042, US

(21) Appl. No.: 11/818,785

(22) Filed: Jun. 15, 2007

(51) Int. Cl. F16K 15/03

(52) U.S. Cl. 137/315.33

(57) ABSTRACT

A top entry in-line repairable swing check valve having a valve body adapted for connection within a flow-line and having flow passages and a valve chamber and further defining a seat recess at the juncture of a flow passage and the valve chamber. A removable seat assembly within the seat recess establishes sealing with the valve body. A swing check member is pivotal within the valve chamber between an open position permitting flow through the flow passages and a closed position in sealing engagement with the seat assembly. The valve body has an access opening to the valve chamber of sufficient dimension for movement of the seat assembly and the swing check member therethrough. A bonnet closure for the access opening supports seat retainer pins positioned in seat retaining relation with the seat assembly. A bonnet orienting pin projects from the valve body and is received by an orienting hole of the bonnet to align the bonnet and seat retainer pins with respect to the valve body.

### BACKGROUND OF THE INVENTION

1. Field of the Invention

The present invention relates generally to valves for controlling the flow of fluids including liquids and gases and concerns swing check valves. More particularly, the present invention concerns a top entry swing check valve having a valve body defining an internal seat recess and having one or more seat retaining pins that are fixed to a removable bonnet defining a removable closure for the valve body. The seat retaining pins function to secure a check valve seat within a seat recess of the valve body. A bonnet orienting pin is employed to ensure proper positioning of the bonnet member relative to the valve body and also ensuring proper positioning of the seat retaining pins relative to the seat member. The present invention also concerns a alternative swing check valve construction that effectives lends itself to check valve mechanisms having a pivotally supported member carrying an annular sealing element which establishes sealing engagement with an annular sealing surface within the valve body.

2. Description of the Prior Art

A wide variety of swing check valves, also referred to as clapper valves, have been developed over the years. For the most part swing check valves are of typically simple character, having a valve body that is connected within a flow line that is subject to flow reversal and having a check valve element or clapper that is pivotally mounted within the valve body for pivotal movement to an open position permitting flow through the flow passages of a valve body and a closed position where the check valve element establishes sealing with a seat surface defined within the valve body or a seat member that is retained within a seat recess within the valve body. Many different varieties of swing check valves have been developed and used for many years.

In most cases the valve bodies of swing check valves must be removed from the flow line in the event repair or replacement is needed. Rather than requiring the flow line to be shut down for an extended period of time, in many cases a defective valve is simply removed from the flow line and is replaced with a serviceable valve. This requires the maintenance of an inventory of serviceable valves and adds significant cost to the processes that require check valve control. Valve removal and replacement operations typically require considerable time and thus significant labor costs which in many cases can be avoided. It is desirable therefore to provide swing check valves that have the capability of being repaired while remaining in the flow line, thus minimizing the inventory and labor requirements for valve maintenance.

A number of top entry, in-line repairable type swing check valves have also been developed for the reasons mentioned above. In many cases these valves are threaded into the seat recesses so that they cannot become inadvertently separated from the valve body as shown by U.S. Pat. No. 3,955,592. However, since threaded seats and seat recesses add somewhat to the complexity and cost of manufacturing a swing check valve mechanism, and since threaded valve seats are often very difficult to remove from their seat recesses, it is desirable to provide swing check valves having replaceable, non-threaded types of seats that are simply positioned within the seat recesses. In such case it is necessary to provide some suitable means for seat retention so that the seat cannot be inadvertently separated from its seat recess by turbulence or other conditions of fluid flow through the valve.

To prevent non-threaded seats from being displaced or fall from the internal valve seats certain seat retainer devices have been provided in the past, as shown by U.S. Pat. No. 4,246,928. In this case retainer pins 70 are received within an annular groove of the valve seat and serve to provide for positive retention of the valve seat, and yet permit its limited movement within the valve seat recess.

U.S. Pat. No. 5,056,548 discloses a swing check valve mechanism having a seat that is retained within a seat recess by retainer pins 71 and 73 which extend through passages 47 and 49 of the valve body structure and provide ends that are received adjacent an annular seat retainer flange 55. In this case it is noted that the retainer pins are retained in position by an interior annular surface 31 that defines the lower end surface of an annular collar 30 projecting from the bonnet member. For seat replacement, the retainer pins must be individually removed from their passages, after the bonnet has been removed, to permit extraction of the annular seat from its seat recess. It is quite obvious from the disclosure of the '548 patent that fouling by the corrosive effects of the fluid being handled can cause the seat retainer pins to be essentially chemically welded, seized or frozen in place. When such conditions exist it can be extremely difficult or impossible to remove the seat retainer pins from their seat retaining positions. While the valve mechanism is designed for in-line repair, if the seat retainer pins cannot be removed under field repair conditions, it may be necessary to remove the valve body from the flow line and transport it to a repair facility. This would require undesired labor costs and cause significant down time of the flow line, thus detracting from the intended use and commercial feasibility of the swing check valve product.

It is a principle feature of the present invention to provide a novel swing check valve mechanism that employs one or more seat retainer pins for retaining a valve seat within a seat recess of the valve body and ensures removal of the seat retainer pins as components of the bonnet closure of the valve.

It is another feature of the present invention to provide a novel swing check valve mechanism that employs a bonnet alignment pin that is fixed to the valve body at the bonnet opening and is received by an alignment pin receptacle of the bonnet closure, thus providing for efficient positioning of the bonnet and the pivotally movable swing check member as the bonnet closure is assembled to the valve body.

Briefly, a top entry in-line repairable swing check valve mechanism that embodies the principles of the present invention is a unidirectional check valve that has a valve body that is adapted for connection within a flow line and defines a valve chamber and flow passages that communicate the valve chamber with the flow line. Cylindrical seat surfaces and annular planar shoulder surfaces within the valve body define a valve seat recess within which is contained an annular seat assembly having a seat recess seal for establishing sealing between the seat assembly and valve body. The seat assembly also carries an annular face seal member which establishes sealing with a swing check member in its closed position to provide for flow responsive valve shut-off in the event flow reversal should occur. The seat assembly includes an annular seat retainer flange that engages an annular shoulder within the valve body when the seat assembly has been inserted to its full extent within the seat recess.

The valve body defines an access opening of sufficiently large internal dimension that the seat assembly and swing check member can be inserted into or removed from the valve chamber via the access opening. A bonnet member is releasably retained in sealed engagement with the valve body and forms a closure for the access opening. Seat retainer pins are fixed to the bonnet member and extend into over-size holes or passages that are defined in an internal swing check member support structure that is an integral part of the valve body. When the bonnet member is in place, inner ends of the seat retainer pins are positioned immediately adjacent to or in contact with the annular seat retainer flange of the seat assembly and prevents the seat assembly from being moved out of its seat recess.

The bonnet member also defines a bonnet alignment hole that receives a bonnet alignment pin that is fixed to and projects upwardly from the valve body. The bonnet alignment hole is also over-size in relation to the dimension of the alignment pin to facilitate ease of bonnet assembly. The bonnet alignment pin ensures that the bonnet is properly aligned with respect to the valve body so that the seat retainer pins will be easily inserted through the seat retainer holes of the valve body and into seat retaining position with respect to the seat retainer flange of the valve seat assembly.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

### In the Drawings:

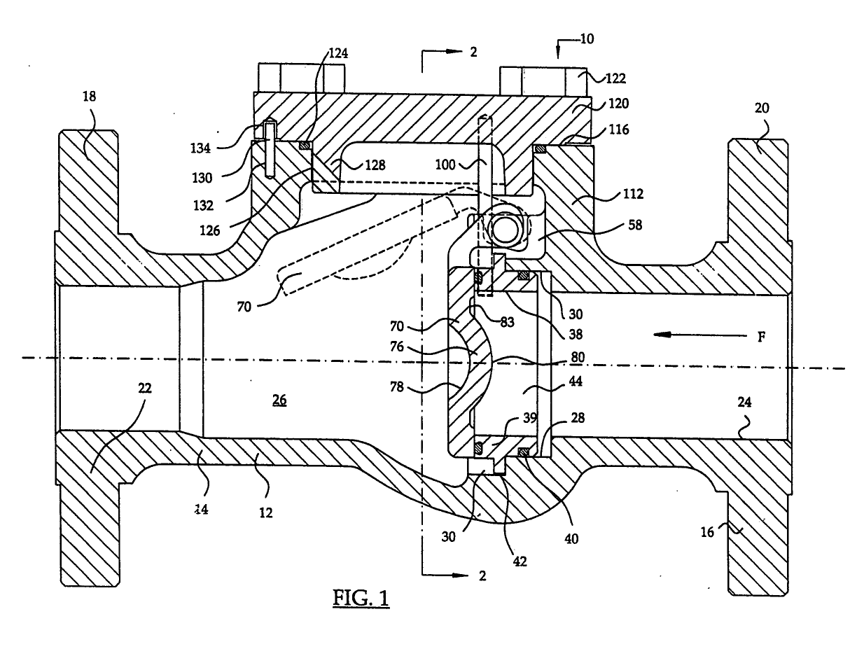

FIG. 1 is a longitudinal sectional view showing a swing check valve embodying the principles of the present invention and showing the swing check member of the valve mechanism at its closed position in full line and at its open position in broken line;

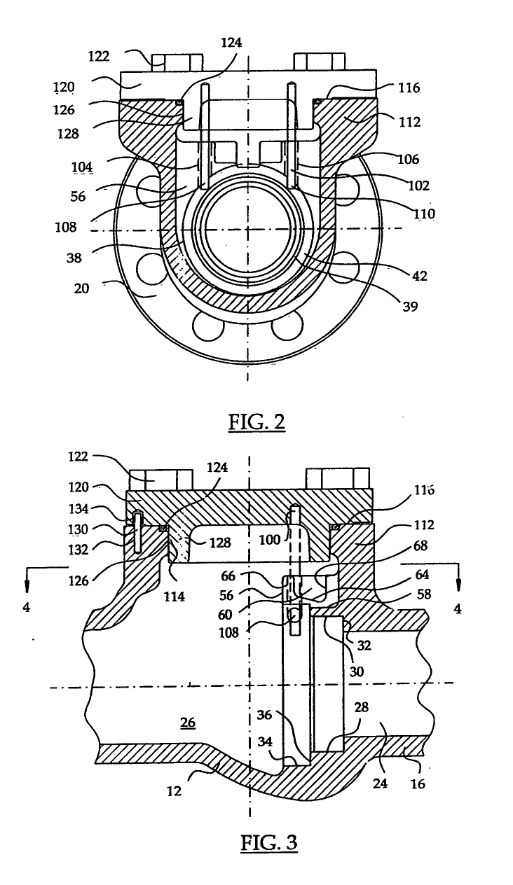

FIG. 2 is a transverse sectional view taken along line 2-2 of FIG. 1, showing the positions of seat retainer pins relative to the valve body, bonnet closure and valve seat;

FIG. 3 is a partial longitudinal sectional view showing the valve body and bonnet closure of FIGS. 1 and 2 and showing a valve seat recess within the valve body with the seat member and swing check member removed;

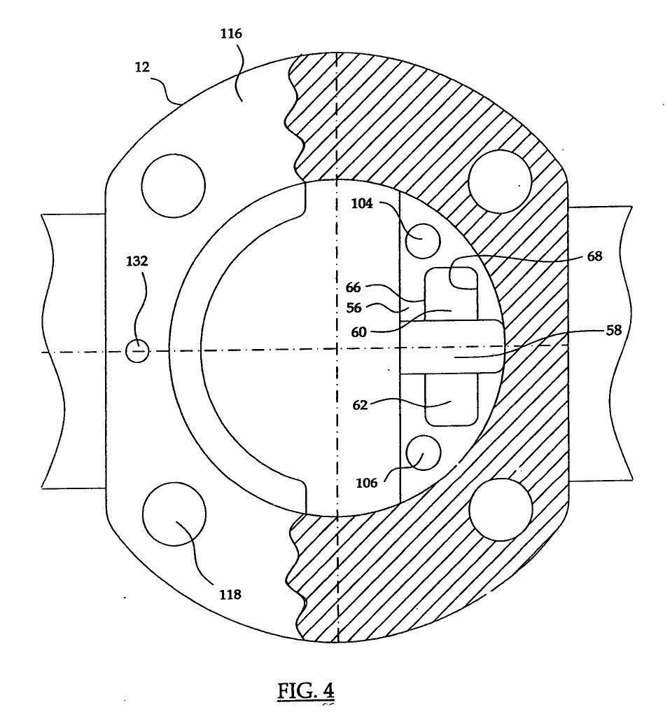

FIG. 4 is a partial sectional view taken along line 4-4 of FIG. 3;

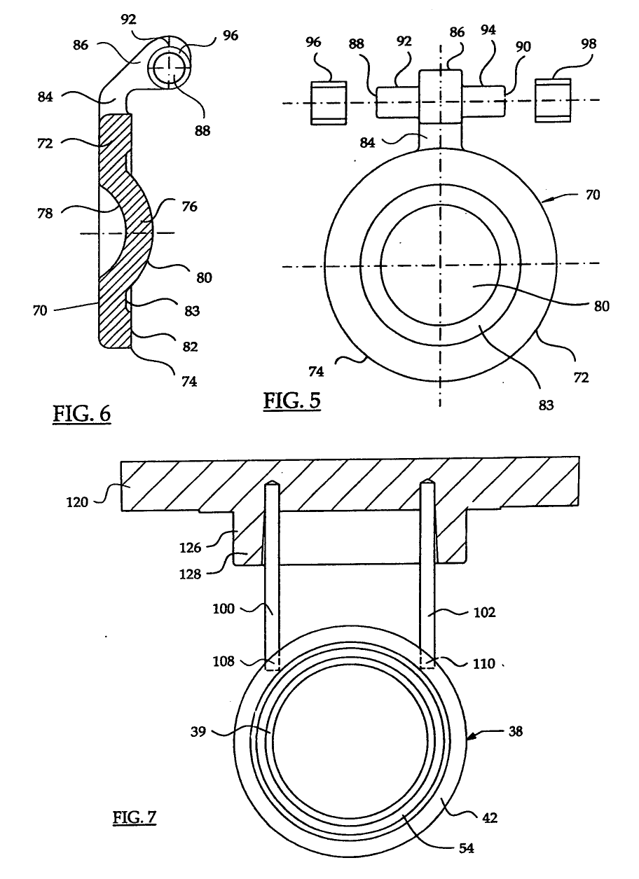

FIG. 5 is an elevation view illustrating the swing check member of FIGS. 1 and 2 and showing the upper portion thereof in exploded fashion to illustrate the pivot shaft and bushings of the swing check member;

FIG. 6 is a side elevation view of the swing check member of FIG. 5, having features thereof shown in broken line;

FIG. 7 is an partial section view showing the relationship of the bonnet closure, seat retainer pins and seat member;

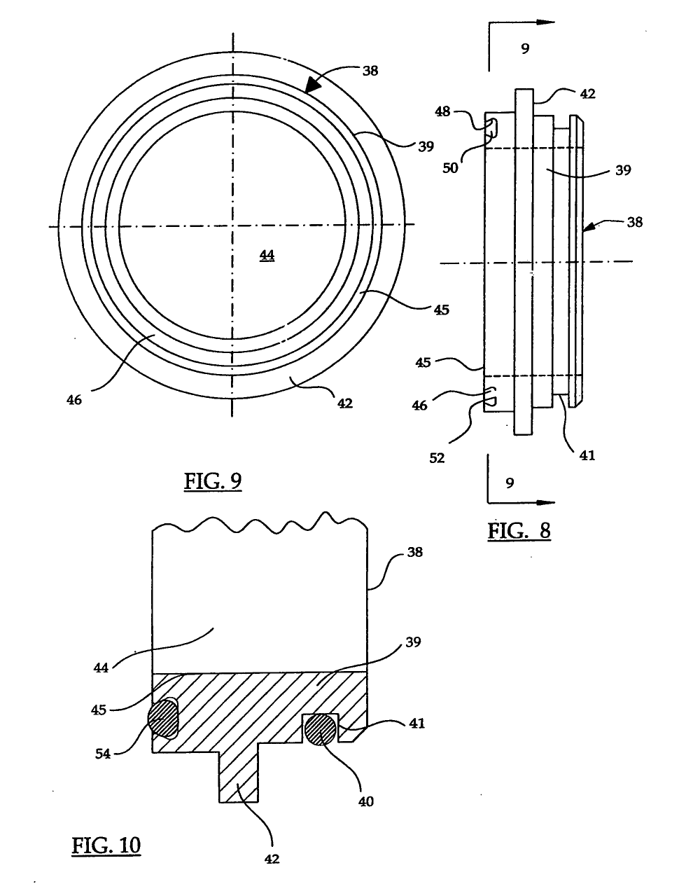

FIG. 8 is a side elevation view showing the seat member;

FIG. 9 is an elevation view of the seat member of FIG. 8, being taken along line 9-9 of FIG. 8;

FIG. 10 is a fragmentary section view of the seat member of FIGS. 8 and 9 showing seal members being contained within a face seal groove and a seat recess seal groove;

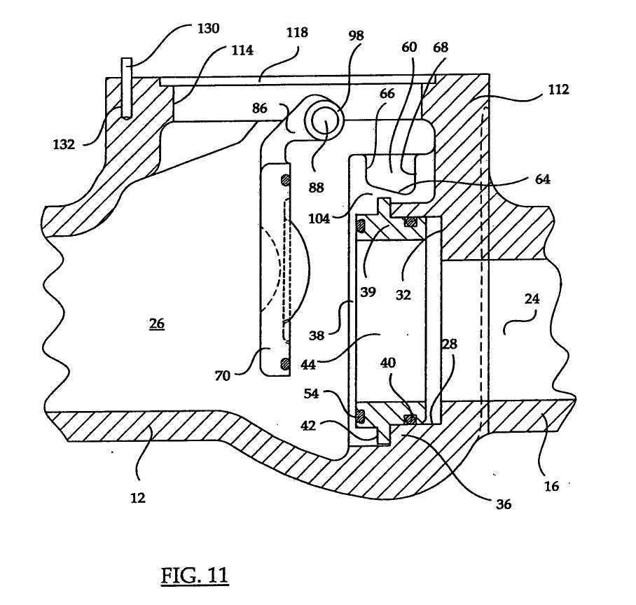

FIG. 11 is a partial sectional view showing the central portion of the valve body of the embodiment of FIGS. 1-10 with the bonnet member removed and illustrating the swing check member position for passing through the access opening during valve assembly or about to pass through the access opening during valve disassembly;

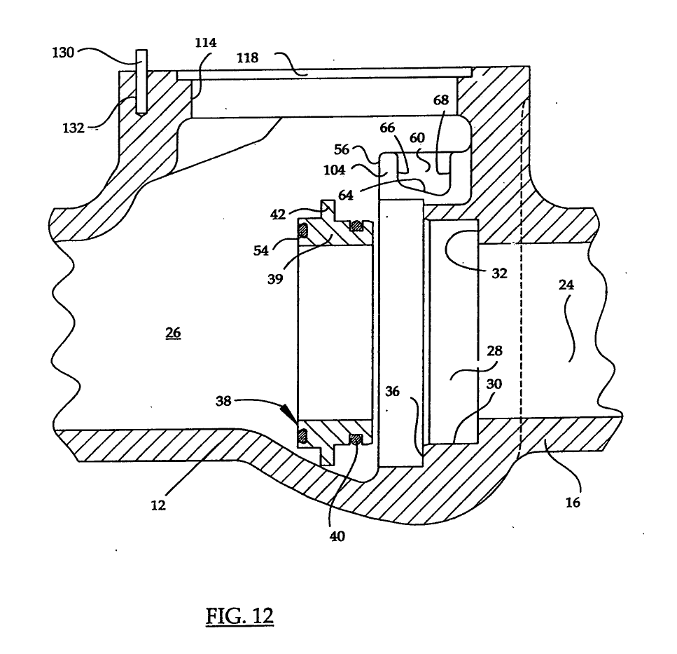

FIG. 12 is a partial sectional view similar to that of FIG. 11 and showing the valve seat assembly in position for assembly within the seat recess during valve assembly or after having been removed from the seat recess during valve disassembly; and

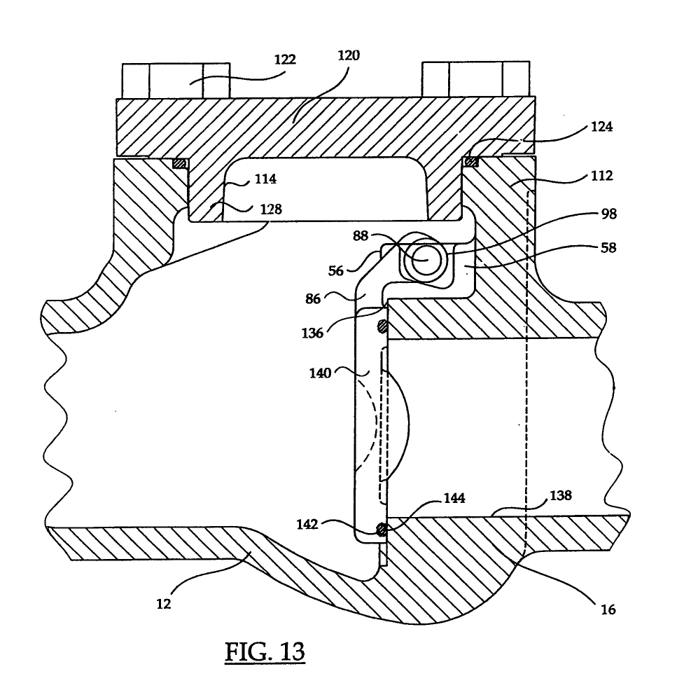

FIG. 13 is a partial sectional view showing the central portion of the valve body of an alternative embodiment of the present invention which differs from the preferred embodiment in that the swing check member carries a face seal for sealing with a metal sealing surface defined within the valve chamber.

### DETAILED DESCRIPTION OF PREFERRED EMBODIMENT

Referring now to the drawings and first to FIGS. 1 and 2, a swing check valve mechanism is shown generally at 10 and comprises a valve body 12 having tubular connection members 14 and 16 each being provided with connection flanges 18 and 20 or other suitable means for connecting the valve mechanism into a flow line. The tubular connection members and connection flanges define internal flow passages 22 and 24 each communicating with a valve chamber 26 defined by the valve body 12 and communicating with the flow line within which the valve mechanism is connected.

With reference to FIGS. 1 and 3, within the valve body a circular seat recess 28 is defined by the valve body 12 and is located in substantially concentric relation with the flow passage 24. The seat recess is formed in part by a cylindrical surface 30 having intersection with an annular seat recess shoulder 32 and includes a concentric enlarged section 34 having an annular shoulder 36.

An annular valve seat assembly shown generally at 38, best shown in FIGS. 8,9 and 10, is located within the circular seat recess 28 and has a metal seat ring structure 39 having an annular seat recess seal member 40 that is retained within an annular seal groove 41 and establishes sealing with the cylindrical surface 30. The annular valve seat member 38 defines an annular seat retainer flange 42 which is of greater dimension as compared with the dimension of the cylindrical surface 30 and is disposed for stopping engagement with the annular shoulder 36 as is evident in FIG. 1. The metal seat ring 39 of the annular valve seat assembly 38 defines a central opening 44 which is of essentially the same dimension as compared with the dimension of the flow passage 24 and is in substantially concentric registry with the flow passage. The metal seat ring 39 of the annular valve seat member 38 also defines an annular face surface 45 having formed therein an annular face seal groove 46 which is shown in FIG. 8 to be defined by angulated or undercut seal retainer surfaces 48 and 50 that have intersection with a circular groove bottom surface 52. Thus, the circular face seal groove is of substantially triangular cross-section and serves to retain a circular face seal member 54 that has substantially the same generally triangular cross-sectional configuration as is evident in FIG. 10. This feature minimizes the potential of the circular face seal member being inadvertently displaced from its seal recess 46 by the flowing fluid when the valve is open or by differential pressure when the valve is closed.

As is evident in FIGS. 1, 3 and 4 The valve body 12 defines internal swing check member support structure 56 which is machined or otherwise formed to define a central valve or clapper support arm relief slot 58 and a pair of transverse shaft receptacle sections 60 and 62, shown best in FIG. 3, that extend from each side of the relief slot. The transverse shaft receptacle sections 60 and 62 are each defined by an angulated groove bottom surface 64 having smoothly curved intersection with generally vertical groove surfaces 66 and 68.

A swing check member or clapper shown generally at 70, which is shown by the exploded elevation view of FIG. 5 and the side elevation view of FIG. 6, comprises a valve plate 72 of generally circular configuration having an annular sealing rim 74. The central portion of the valve plate 72 is of domed configuration, with an integral curved dome 76 facing upstream with respect to the direction of flow through the valve that is identified by flow arrow “F”. With the swing check member 70 in its closed position as shown in FIG. 1 flow of fluid through the valve cannot occur. The integral curved dome 76 defines a curved concave surface 78 and a curved convex surface 80 as is best shown in FIG. 6. The annular sealing rim 74 defines a planar annular sealing surface 82 which, in the closed condition of the swing check member 70 establishes sealing engagement with the annular face seal 54 of the seat member 38 and establishes supported engagement with the annular face surface 45 of the seat member. Between the planar sealing surface 82 of the annular sealing rim 74 and the integral curved dome 76 is defined a circular recess 83.

A support arm 84 extends upwardly from the valve plate 72 and may be integral with or fixed to the valve plate in any suitable fashion. An upper portion 86 of the support arm extends upwardly and laterally from the valve plate and supports a pair of opposed pivot shaft members 88 and 90. The pivot shaft members 88 and 90 are of generally cylindrical configuration and define external cylindrical surfaces 92 and 94 about which are received bushing members 96 and 98 that are best shown in FIGS. 5 and 6. The location of the pivot shaft members is laterally offset from the sealing position of the domed valve plate 72 in relation to the face seal 54 of the seat assembly 38. Thus, the valve plate is urged against the face seal with sufficient counterbalance force to establish a seal even when the valve is not under pressure. In the event of the development of a pressure condition within the valve chamber upstream of the valve plate and seat assembly the valve plate will be at its closed position and thus no valve leakage or flow condition will occur. Pressure from the opposite direction, i.e., within flow passage 24 will pivot the valve plate clockwise toward its open position, permitting flow through the valve mechanism. Flow reversal from this condition will simply cause the valve plate member 70 to be pivoted to its closed position, as shown in FIG. 1, thus preventing any condition of fluid flow in the reverse direction.

When the swing check member or clapper 70 is installed for pressure responsive pivotal movement within the valve chamber 26 the bushing members 96 and 98 will be in contact with the angulated groove bottom surface 64. Because of the taper of the groove bottom surface, the bushing members will have a tendency to move rearwardly or toward the right as shown in FIG. 3 so that the bushings will also be in positioning engagement with the rearmost generally vertical groove surfaces 68. It should be noted that the spacing of the generally vertical groove surfaces 66 and 68 is greater than the diametric dimension of the bushing members, thus permitting the bushing members to have freedom of lateral movement within the transverse shaft receptacle sections 60. This feature permits pivot shaft and bushing movement within the transverse shaft receptacle sections 60 and thus permits the swing check member 70 to have the freedom to seek its optimum sealing relation with the seat member 38 when the swing check member is moved to its closed position.

In the case of top entry in-line repairable swing check valves it is necessary that the valve seats be rather easily removable so as to minimize the labor that is required for their removal and replacement. It is also appropriate that the valve be designed for field repair via the use of simple, commercially available tools. Often the fluid being controlled by a valve contains corrosive constituents that causes the seats to become seized within their seat recesses. Threaded valve seats are particularly difficult to remove and replace because they must be rotated for removal. If the valve seat is seized within its seat recess, seat rotation may not be possible. The only logical solutions are to remove the valve from the flow line and transport it to a repair facility or to transport special repair tools to the site of the valve and attempt to repair it in place. It is this undesirable condition for which the present invention has been developed.

In the case of the present invention the valve seat is of simple, generally cylindrical configuration and the valve seat is sealed with respect to a cylindrical internal seat recess wall surface by the seat recess seal member 40. The valve seat is installed simply by pushing it into the seat recess until the annular seat retainer flange 42 of the seat establishes movement limiting contact with the internal annular shoulder 36. To ensure that the valve seat will remain within the seat recess during operating conditions a pair of valve seat retainer pins 100 and 102, shown in FIGS. 1,2 and 7, extend through retainer pin openings or passages 104 and 106 that are defined in the internal swing check member support structure 56, shown in FIG. 4. Lower ends 108 and 110 of the seat retainer pins extend into the annular space that is defined by the concentric enlarged section 34 of the seat recess 28 and serve as retainers to restrain unseating movement of the valve seat by restricting unseating movement of the annular flange 42 of the seat. Thus the seat retainer pins ensure that the annular seat member 38 is maintained in operative position within the seat recess and cannot become displaced until such time as its removal is intended. The openings or passages 104 and 106 of the internal swing check member support structure 56 have an internal dimension that is significantly greater than the external dimension of the seat retainer pins 100 and 102, thus ensuring sufficient space for simple and efficient insertion of the seat retainer pins during assembly of the valve mechanism. Also, the over-size nature of the openings 104 and 106 minimize the potential that the seat retainer pins might become seized or frozen in place by corrosion activity or by deposits of line scale, sediment or other undesirable conditions.

The valve body 12 defines an upwardly extending annular bonnet connection section 112 defining a bonnet flange opening 114. An upwardly facing bonnet seal surface 116 and an internal bonnet seal groove 118 are defined by the annular bonnet connection section 112. A circular bonnet member 120 is secured to the annular bonnet connection section 112 by means of a plurality of bolt and nut assemblies or threaded stud and nut assemblies 122. A circular bonnet seal member 124 is positioned within the bonnet seal groove 118 and establishes sealing between the annular bonnet connection section 112 and the bonnet member 120. The circular bonnet seal member 124 is also retained in position by an external annular surface 126 that is defined by an annular flange 128 that is integral with and depends from the lower portion of the bonnet member 120. The annular flange 128 also serves as a bearing and pivot shaft retainer

It is desirable to ensure that the seat retainer pins 100 and 102 are relatively easy to remove from their passages 104 and 106 to provide for removal of the valve seat from its seat recess during in-line repair. To facilitate this feature the upper ends of the seat retainer pins are fixed to the bonnet member 120 and depend from the bonnet member through the retainer pin openings 104 and 106 to the seat retaining positions shown in FIGS. 1-3 and 7 of the drawings. The seat retainer pins may be press-fitted within bonnet pin openings of the bonnet member or may be threaded into threaded holes in the bonnet as desired. If desired, the seat retainer pins may be tack welded whether press-fitted or threaded to the bonnet.

Since the bonnet retainer pins 100 and 102 are fixed to the bonnet member 120, it is necessary that the bonnet member be properly aligned with the annular bonnet connection section 112 so that the seat retainer pins will be properly oriented with respect to the retainer pin openings 104 and 106. This feature is provided by a bonnet alignment pin 130 that is press-fitted within an alignment pin opening 132 of the annular bonnet connection section 112 so that it projects upwardly therefrom. The bonnet member 120 defines a downwardly facing alignment pin opening 134 that receives the alignment pin only when the bonnet member has been properly positioned relative to the annular bonnet connection section 112. Alternatively, if desired the bonnet alignment pin may be fixed to the bonnet member in any suitable fashion and may project into an opening of the valve body.

The partial sectional view of FIG. 11 presents the central portion of the valve body and shows the bonnet member 120 removed and the valve seat assembly 38 in place within the seat recess 28. The swing check member 70 is shown having its pivot shafts and bearings separated from the transverse shaft receptacle sections 60 and 62 and being positioned within the valve chamber. During valve disassembly from the position of the swing check member 70 shown in FIG. 11, is in position for upward movement through the valve chamber access opening 114, leaving only the valve seat assembly to be extracted and repaired or replaced during field repair. During assembly of the valve mechanism the swing check position shown in FIG. 11 indicates that the swing check member has passed through the access opening 114 and only needs to be shifted laterally to the right to bring its pivot shafts and bushings in registry with the transverse shaft receptacle sections 60 and 62 of the support structure 56. When the pivot shafts and bushings have been so positioned, the swing check member will pivot downwardly and seek its optimum sealing position relative to the face seal member of the seat assembly. The weight of the plate section of the swing check member is counter-balanced with respect to the position of the pivot that is defined by the pivot shafts, thus causing the plate section to engage the valve seat with sealing force even when the valve mechanism is not under conditions of pressure or flow.

Referring to FIG. 12 the partial sectional view is similar to that of FIG. 11 except that the Figure shows the seat assembly separated from the seat recess 28. The position of the seat assembly shown in FIG. 12 can represent the seat assembly having been extracted from the seat recess or in position for insertion into the seat recess. During disassembly operations the seat assembly is extracted from its seat recess 28 and is then withdrawn from the valve chamber 26 and repaired or replaced. Repair of the seat assembly is typically accomplished simply by replacing the seal members. If the metal seat ring component is found to be deteriorated in any manner, then a new seat assembly will be employed to restore the valve mechanism to its proper operating capability. The new or repaired seat assembly is then passed into the valve chamber 26 through the access opening 114 and is brought into alignment with the seat recess 28. Typically the seat assembly is placed within the seat recess by a hand operation since the annular seat recess seal member 40 will establish only light interference sealing engagement with the cylindrical surface 30 of the seat recess. In some cases, especially to ensure sealing between the seat assembly and valve body at low pressure as well as high pressure, the seat assembly will need to be moved into fully seated relation within the seat recess with sufficient force to seat the seat assembly completely and insure that the annular seat recess seal member 40 establishes fluid tight sealing with the cylindrical surface 30 even when the valve mechanism is not under pressure. The valve seat assembly 38 is moved into the seat recess until the annular flange 42 has established contact with the annular shoulder 36 of the seat recess.

After the seat assembly 38 and the swing check member 70 and its pivot bushings have been installed, the bonnet member 120 is then installed and secured in sealed assembly with the upwardly extending annular bonnet connection section 112 as explained above. Typically a new bonnet seal member 124 will be installed within the bonnet seal recess 118 to ensure the sealed integrity of the bonnet and valve body connection. When the bonnet member is installed, the bonnet member will be positioned so that the downwardly facing alignment pin opening 134 receives the alignment pin 130. This also causes the seat retainer pins 100 and 102 to be properly aligned with respect to the openings or passages 104 and 106 of the internal swing check member support structure 56. Since the downwardly facing alignment pin opening 134 of the bonnet member and the seat retainer pin openings 104 and 106 are each oversize in comparison with the dimension of the respective pins, assembly of the bonnet member is achieved quite easily. The seat retainer pins, being fixed to the bonnet member will be easily moved into seat retaining position relative to the annular seat retainer flange 42, thereby preventing the seat assembly from inadvertently moving out of its seat recess 28.

With reference to FIG. 13, a swing check valve representing an alternative embodiment of the present invention is shown by a partial sectional view illustrating the central portion of the valve body. This alternative embodiment differs from the preferred embodiment of FIGS. 1-12 only in the characteristics of its swing check member and valve seat member. Like parts are referred to by like reference numerals as compared with the embodiment of FIGS. 1-12. The valve body 12 is internally machined to define an annular generally planar valve seat 136 which is oriented in substantially perpendicular relation to a flow passage 138 of the valve body 12. A swing check member 140 is provided, having substantially the same domed configuration as discussed above in connection with swing check member 70. The swing check member 140 defines a face seal groove 142 within which is secured a face seal member 144 that may be composed of any of a number of suitable sealing materials that differ according to the conditions of service in which the valve mechanism is to be used. The face sealing material and the seal members shown in FIGS. 1-12 will be selected according to the various service conditions that are intended, such as fluid characteristics, corrosiveness of the fluid medium, temperature of operation and operating pressure, etc.

### Assembly and Disassembly Operations

When a swing check valve embodying the principles of the present invention is in need of in-line repair, such as by replacement of the valve seats, seat seals, swing check member or pivot shaft bushing members, the bonnet member 122 is released from its sealed assembly with the annular bonnet connection section 112 of the valve body by removing the bolts or stud and nut assemblies 122. As the bonnet member 122 is removed the seat retainer pins 100 and 102, being fixed to the bonnet, will be removed along with the bonnet. The bonnet alignment pin, being fixed to the annular bonnet connection section 112, will remain in place. Since the depending bonnet flange will no longer be in place within the valve chamber access opening 114 of the annular bonnet connection section 112, the pivot shaft bushings and the pivot shafts will no longer be restrained thereby. The swing check member and its pivot shaft bushings will be moved upwardly through the valve chamber access opening 114 where they will be inspected and repaired or replaced. Typically, new pivot shaft bushings will be installed on the pivot shaft, if the swing check member 70 is not corroded, eroded or otherwise worn, and a new valve or repaired valve seat assembly will be installed. However, if the metal valve seat ring is in good condition then new seal members may be installed, without any need to replace the metal seat ring component.

Since the valve seat 38 of the present invention is not threaded into the seat recess 28 the seat can be extracted from the seat recess simply by moving it linearly to the left from the position shown in FIG. 1. Since an annular space will typically exits behind or on the downstream side of the seat ring, as is the case shown in FIG. 1, a seat extractor with simple hook-like fingers can be used. If the seat recess seal will not release easily or if the seat ring is somewhat frozen in place, the extractor can be positioned with its extraction fingers extending through the central opening of the seat ring and with hook-like extremities of the extraction fingers located within the annular space or groove and engaging. By applying force in the linear direction for seat extraction, the annular valve seat ring 38 is usually easily removed from its seat recess. Seat extraction is made possible because the seat retainer pins will have been removed from their seat restraining positions when the bonnet member 120 is unbolted and removed from the upwardly extending annular bonnet connection section 112 of the valve body 12. Typically the seat retainer pins will be easily withdrawn from the oversize holes or passages 104 and 106 of the swing check support structure 56.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A top entry in-line repairable swing check valve, comprising:
a valve body adapted for connection within a flow-line and having flow passages and a valve chamber and further defining a seat recess at the juncture of a flow passage and the valve chamber and defining an internal seat recess;
a seat assembly being received within said seat recess and establishing sealing with said valve body;
a swing check member being mounted to said valve body within said valve chamber and being supported for pivotal movement between an open position permitting flow through said flow passages and a closed position in sealing engagement with said seat assembly
said valve body defining an access opening to said valve chamber of sufficient dimension for movement of said seat assembly and said swing check member therethrough;
a bonnet member being removably assembled to said valve body and defining a closure for said access opening; and
a seat retainer member being fixed to said bonnet member and extending into said valve chamber and having a portion thereof positioned in seat retaining relation with said seat assembly.

2. The top entry in-line repairable swing check valve of claim 1, comprising:
said seat assembly having a seat retainer portion disposed in seat positioning engagement with said valve body; and
said seat retainer member having a portion thereof disposed for seat retaining engagement with said seat retainer portion of said seat assembly.

3. The top entry in-line repairable swing check valve of claim 1, comprising:
a bonnet alignment member disposed to ensure aligned position of said bonnet member relative to said valve body.

4. The top entry in-line repairable swing check valve of claim 1, comprising:
a bonnet alignment pin projecting from said valve body;
a bonnet alignment opening being defined in said bonnet member and receiving said bonnet alignment pin when said bonnet member is properly aligned relative to said valve body.

5. The top entry in-line repairable swing check valve of claim 1, comprising:
internal swing check support structure being defined within said valve body and having seat retainer passages formed therein; and
said seat retainer member being a pair of seat retainer pins being fixed to said bonnet member and projecting through said seat retainer passages and having seat retaining ends thereof positioned in retaining engagement with said seat assembly.

6. The top entry in-line repairable swing check valve of claim 1, comprising:
internal swing check support structure being defined within said valve body and having seat retainer passages formed therein;
said seat retainer member being a pair of seat retainer pins being fixed to said bonnet member and projecting through said seat retainer passages and having seat retaining ends thereof positioned in retaining engagement with said seat assembly;
a bonnet alignment pin projecting from said valve body; and
a bonnet alignment opening being defined in said bonnet member and receiving said bonnet alignment pin when said bonnet member is properly aligned for positioning of said seat retainer pins for location within said seat retainer passages.

7. A top entry in-line repairable swing check valve, comprising:
a valve body adapted for connection within a flow-line and having a valve chamber and flow passages having intersection with said valve chamber, said valve body further defining a seat recess within said valve chamber and defining a swing check member support structure having seat retainer passages extending to said seat recess;
a seat assembly being received within said seat recess and establishing sealing with said valve body, said seat assembly having an annular seat retainer flange;
a swing check member being mounted within said valve chamber and being supported by said swing check member support structure for pivotal movement between an open position permitting flow through said flow passages and a closed position in sealing engagement with said seat assembly;
said valve body defining an access opening to said valve chamber of sufficient dimension for movement of said seat assembly and said swing check member therethrough;
a bonnet member being removably assembled to said valve body and defining a closure for said access opening, said bonnet member defining an alignment opening;
a bonnet alignment pin projecting from said valve body being received within said alignment opening when said bonnet member is position in properly aligned relation with said valve body; and
a pair of seat retainer pins being fixed to said bonnet member and extending through said seat retainer passages into said seat recess and having portions thereof positioned in seat retaining relation with said annular seat retainer flange of said seat assembly.

8. The top entry in-line repairable swing check valve of claim 7, comprising:
said swing check support structure having a pivot arm recess and opposed pivot shaft recesses;
said swing check member having a support arm extending upwardly and angularly therefrom and being received by said pivot arm recess and defining opposed pivot shafts being located for pivotal movement within said pivot shaft recesses; and
bushing members being positioned about said opposed pivot shafts and being interposed between said pivot shafts and said opposed pivot shaft recesses.

9. The top entry in-line repairable swing check valve of claim 7, comprising:
said seat retainer passages being defined in said internal swing check support structure and being open toward said bonnet member and being open to said seat recess; and
said pair of seat retainer pins extending from said bonnet member through said seat retainer passages and having ends thereof positioned in movement limiting relation with said an annular seat retainer flange.

10. The top entry in-line repairable swing check valve of claim 7, comprising:
said bonnet member defining a pair of seat retainer pin receptacles; and
said pair of seat retainer pins being press-fitted within said pair of seat retainer pin receptacles and being withdrawn from said seat retainer passages upon disassembly and removal of said bonnet member from said valve body.

11. The top entry in-line repairable swing check valve of claim 7, comprising:
said seat retainer passages being of significantly greater internal dimension as compared with the outer dimension of said pair of seat retainer pins so that said seat retainer pins are loosely received within said seat retainer passages.

12. The top entry in-line repairable swing check valve of claim 7, comprising:
said alignment opening of said bonnet member being of significantly greater internal dimension as compared with the outer dimension of said bonnet alignment pin so that said bonnet alignment pin is loosely received within said alignment opening.
